(19) United States
(12) Patent Application Publication
(10) Pub. No.: US 2005/0062722 A1
(43) Pub. Date: Mar. 24, 2005

(54) Keyboard for displaying host operating conditions

(76) Inventor: You-Jun Hsieh, Taipei Hsien (TW)

Correspondence Address: BIRCH STEWART KOLASCH & BIRCH, PO BOX 747, FALLS CHURCH, VA, 22040-0747, US

(21) Appl. No.: 10/668,197

(22) Filed: Sep. 24, 2003

(51) Int. Cl. G09G 5/00

(52) U.S. Cl. 345/168

(57) ABSTRACT

A keyboard for displaying host operating conditions displays operating information such as temperature of CPU and hard disk drives and rotation speed of radiator fan and provides control. A display device and a rotation speed regulator are located on the operation side of the keyboard that faces and is visible to users. The keyboard contains a display micro-control unit to actuate the display device. The information of the temperature of CPU and hard disk drives and the rotation speed of radiator fan detected by the host are directly displayed on the visible location of the keyboard so that users can directly read the temperature of CPU and hard disk drives and rotation speed of radiator fan from the operation side of the keyboard, and control the rotation speed of the radiator fan through the rotation speed regulator. Operation and monitoring is much easier.

### FIELD OF THE INVENTION

The present invention relates to keyboards of computers and particularly to a keyboard capable of displaying and monitoring host operating conditions such as temperature of CPU and hard disk drives and rotation speed of radiator fan.

### BACKGROUND OF THE INVENTION

There are two main developing trends for electronic products at present, one focuses on slim size and light weight, another focuses on high performance and multiple functions. With increasing heat energy generation and continuous shrinking of the size of elements, heat density also increases rapidly. If heat energy cannot be dispersed effectively, the performance and reliability of electronic products will be seriously affected, even service life will be reduced.

For the CPU of present desktop computers, Heating-Transferred Memory Module Assembly consisting of aluminum radiation fins coupled with a radiator fan is a mandatory feature. However, with the heat energy increased continuously, investments on technology development to improve the heat-sink module and monitoring of CPU temperature still are necessary to meet future challenges. CPU temperature is critical to operation reliability and efficiency. This is especially true in the “over clocking” environment in which the CPU operates at an operation frequency beyond the range defined in the specifications. In such an environment CPU requires a greater power and generates a much higher temperature. Therefore all major CPU vendors such as Intel and AMD, and all mainboard producers have viewed CPU temperature measurement and detection as an important issue, and have tried to provide a better monitoring and control for the rotation speed of the radiator fan in the (Heating-Transferred Memory Module Assembly).

Detection of a conventional CPU usually is accomplished by parallel bonding a temperature sensor (such as a thermal resistor) to the center point of the bottom surface (where the pins are located) of the CPU die. Then a software or hardware is used to display the temperature on a display terminal. The rotation speed of the radiator fan may also be controlled through software. Based on the detected temperature (may be CPU temperature or temperature difference between the intake air of the radiator fan and CPU), the rotation speed of the radiator fan may be controlled. However, the window on the display terminal for displaying the information such as CPU temperature and rotation speed of the radiator fan usually is very small and difficult for users to read. Or the window for displaying CPU temperature and rotation speed of the radiator fan is hidden and invisible in normal conditions, and becomes visible only after users select through a pointing device such as a mouse. It is not convenient in use. Although some host manufacturers have provided a display device on the host panel to indicate CPU temperature and rotation speed of the radiator fan, the present hosts mostly adopt floor standing design. Therefore to see and read information is still not convenient.

### SUMMARY OF THE INVENTION

The primary object of the invention is to provide a keyboard that is capable of displaying operating conditions of the host such as the temperature of CPU and hard disk drives, and rotation speed of radiator fan.

The invention adopts a standard keyboard and includes a display device on the operation side of the input device. The display device may be a liquid crystal display (LCD) device or a light emitting diode (LED) display device. The information such as temperature of CPU and hard disk drives, and rotation speed of radiator fan detected by the host are transferred to a display micro-control unit (MCU) built in the keyboard. Then the MCU actuates the display device to display the temperature of CPU and hard disk drives, and rotation speed of radiator fan.

By means of the aforesaid design, users can instantly get the information such as the temperature of CPU and hard disk drives, and rotation speed of radiator fan on the visible portion of the keyboard without resorting to operation software, thus use convenience may increase.

Another object of the invention is to provide a keyboard that can adjust the rotation speed of the radiator fan.

Yet another object of the invention is to provide a keyboard that can generate warning signal when the temperature of CPU and hard disk drives rises to a preset temperature level.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of a first embodiment of the present invention.

FIG. 2 is a functional block diagram of the first embodiment of the present invention.

FIG. 3 is a schematic view of the display device of the keyboard indicating CPU temperature and rotation speed of the radiator fan.

FIG. 4 is a perspective view of a second embodiment of the present invention.

FIG. 5 is a functional block diagram of the second embodiment of the present invention.

FIG. 6 is a perspective view of a third embodiment of the present invention.

### DETAILED DESCRIPTION OF THE PREFERRED EMBODIMENTS

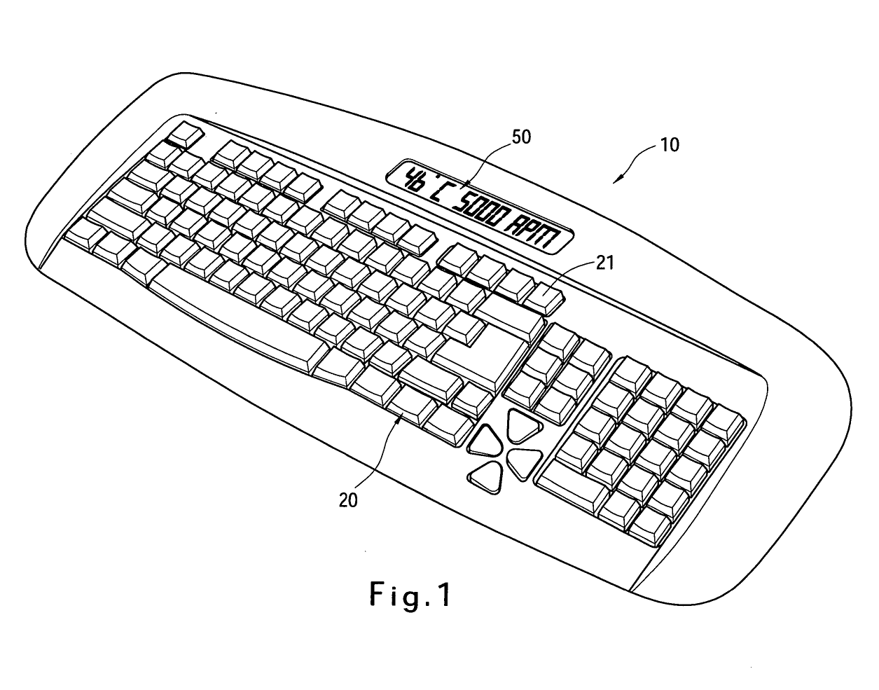

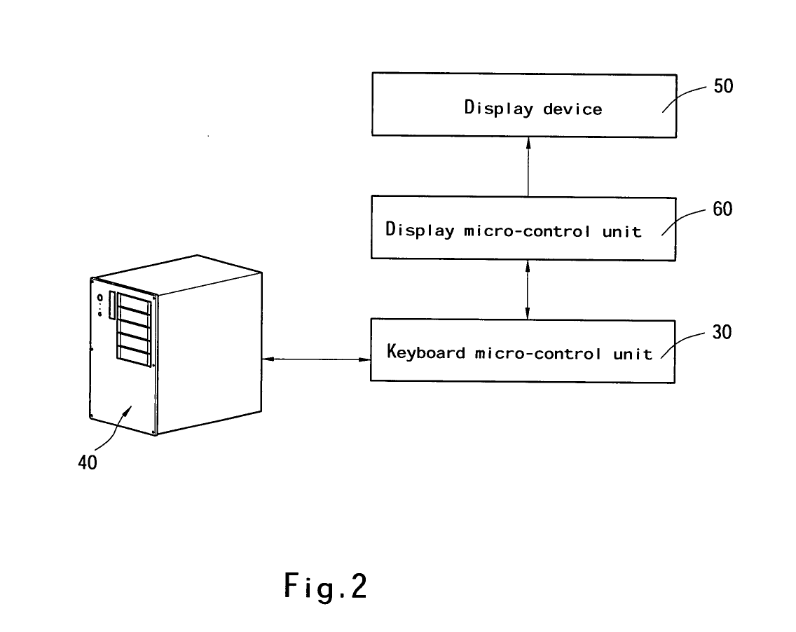

Please referring to FIGS. 1 and 2, the keyboard for displaying host operating conditions 10 (abbreviated keyboard 10 hereunder) according to the invention is structured based on a general standard keyboard to serve as one of the input peripheral devices of a host 40. It consists of:

a standard key set 20 that includes a plurality of button keys 21 for entering digital data that include all English character keys, numeral keys, special function keys (such as F1-F12), direction keys (such as up, down, left, right) and the like;

a keyboard micro-control unit (MCU) 30 serving as a communication interface between the keyboard 10 and the host 40. For instance, when any of the button keys 21 is depressed by users, a digital code corresponding to the button key 21 will be generated and output to the host 40 which is connected to the keyboard 10. It also receives information signals transferred from the host 40 that include temperature of CPU and hard disk drives and rotation speed of radiator fan;

a display device 50 located on the operation side of the keyboard 10 for displaying the information transferred from the host 40; and

a display micro-control unit (MCU) 60 for controlling display information on the display device 50 according to the signals transferred from the host 40.

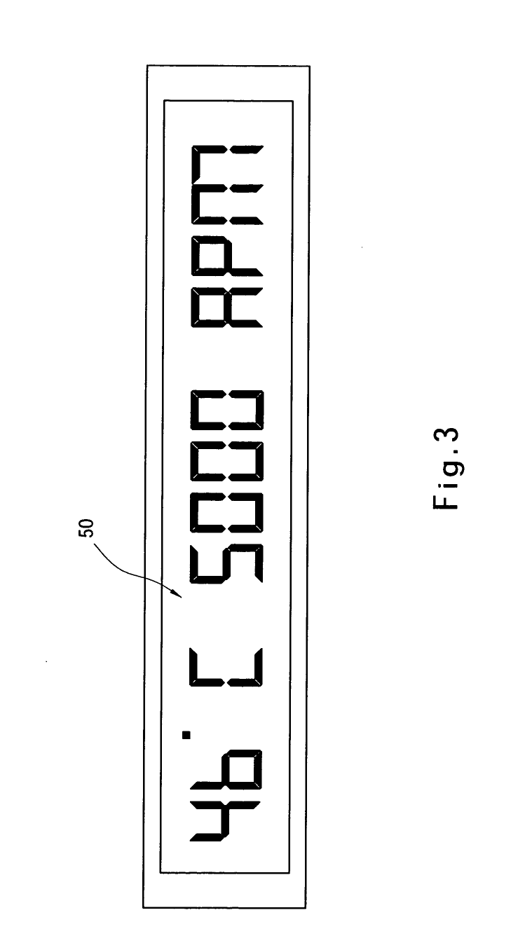

In general the temperature of the CPU in the host 40 and the hard disk drives are detected by parallel bonding a temperature sensor (such as a thermal resistor) to the center point of the bottom surface of the CPU die and the surface of the circuit board of the hard disk drives. The host 40 controls the rotation speed of the radiator fan based on the detected temperature. A more advanced design is to detect the temperature difference between the air intake of the radiator fan and the CPU surface, and based on the temperature difference to control the rotation speed of the radiator fan. The information of the temperature of CPU and hard disk drives and the rotation speed of the radiator fan are delivered through a monitoring program (generally built-in the host mainboard). The invention transfers the information that include the temperature of CPU and hard disk drives and the rotation speed of the radiator fan through the interface connecting to the keyboard 10 to the keyboard MCU 30. Then the keyboard MCU 30 transfers the information to the display MCU 60 which actuates the display device 50 to display CPU temperature and the rotation speed of the radiator fan (referring to FIG. 3).

According to a preferred embodiment of the keyboard 10 of the invention, the display device 50 is located on the operation side (usually the side facing and visible to users) of the keyboard 10. The display device 50 may be a LCD or LED type, and at least can display bitmapped fonts. Hence user can instantly get the information such as the temperature of CPU and hard disk drives and the rotation speed of the radiator fan on the visible portion of the keyboard 10 without resorting to operation software, thus use convenience improves.

As the keyboard 10 includes the display device 50 for displaying the temperature of CPU and hard disk drives and the rotation speed of the radiator fan, and the host 40 now provided by host mainboard or CPU vendors has built-in function in to detect CPU temperature and rotation speed of radiator fan, users can connect the keyboard 10 of the invention to different types of hosts and instantly read CPU temperature and rotation speed of radiator fan.

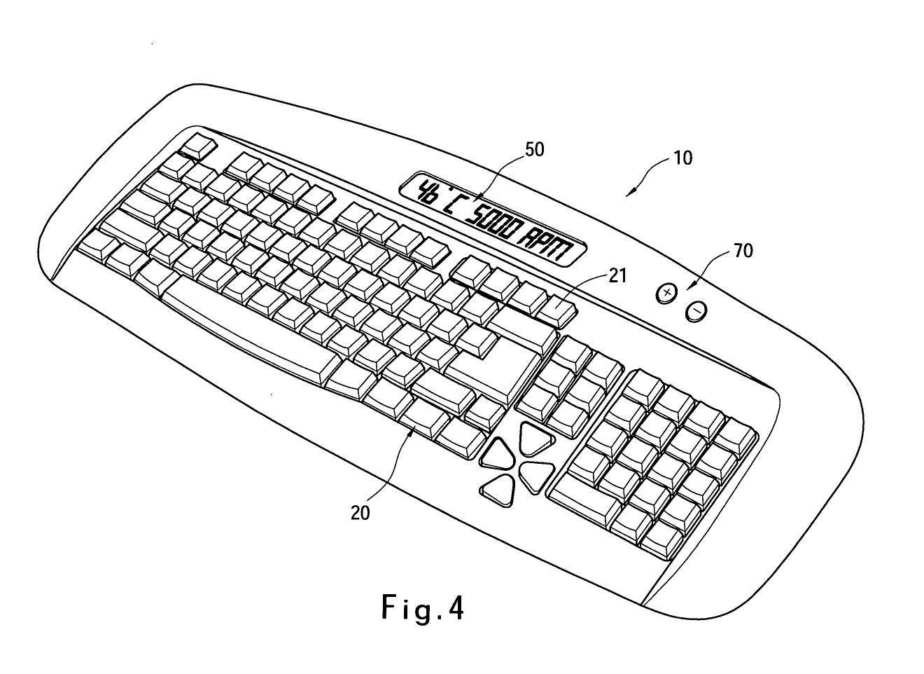

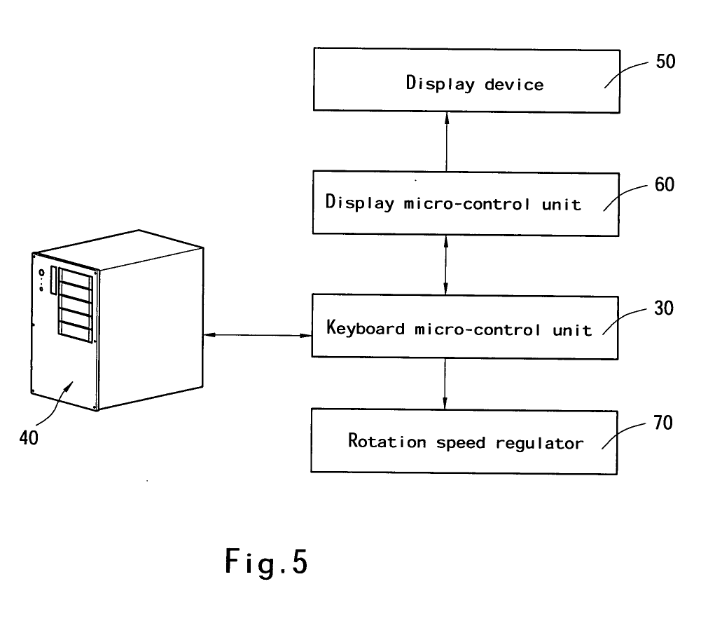

Refer to FIGS. 4 and 5 for a second embodiment of the invention. The keyboard 10 further has a rotation speed regulator 70 on the operation side. Based on the temperature information displayed on the display device 50, users can manually adjust the rotation speed of the radiator fan through the rotation speed regulator 70. After the rotation speed regulator 70 has been adjusted, the adjusting signal is encoded by the keyboard MCU 30 and transferred to the host 40 which decodes and processes to alter the rotation speed of the radiator fan as desired.

In FIG. 4 the rotation speed regulator 70 is made in pushbuttons. However, any other equivalent elements and alterations may be adopted, such as turning knobs, endless variable resistors, multi-stage toggle switches, etc.

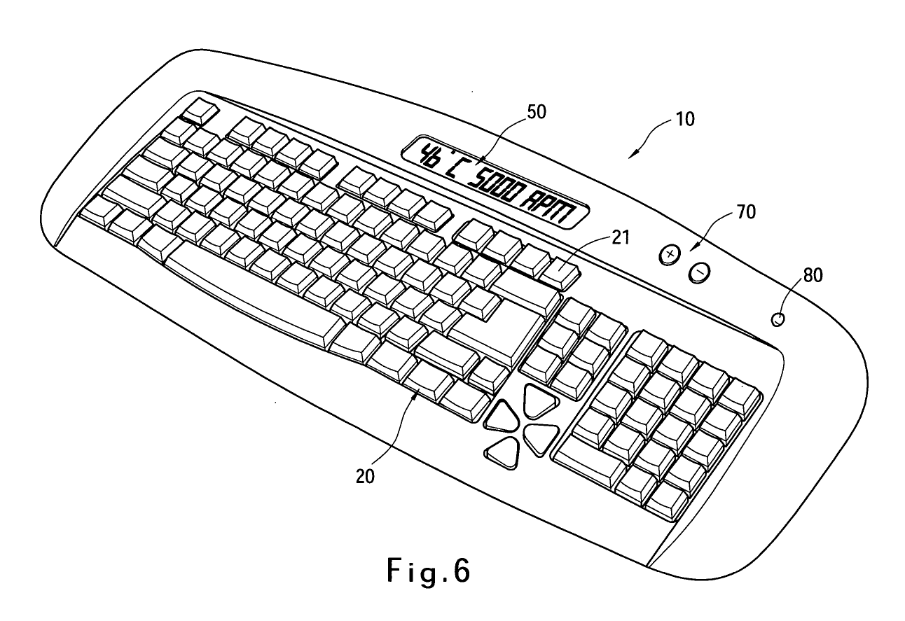

Refer to FIG. 6 for yet another embodiment of the invention. The operation side of the keyboard 10 may further include an alarm unit 80 so that when the temperature of CPU and hard disk drives rises and exceeds a preset temperature level, an alarm signal will be generated to alert users. In FIG. 6, the alarm device 80 is a lighting element (such as LED, or lighting bulb) to provide a visible signal. Of course, the alarm unit 80 may also be an audio element (such as a speaker) or a combination of a lighting element and an audio element. The preset temperature may be set through software or firmware. When the host 40 detects the temperature of CPU and hard disk drives exceeding the preset temperature, a warning signal will be generated to the keyboard MCU 30 which actuates the alarm unit 80 to generate a sound or lighting signal or a combination of sound and lighting signals to alert users to take proper measures.

1. A keyboard for displaying host operating conditions to display information including temperature of a central processing unit (CPU) of a computer and rotation speed of a radiator fan, comprising:
a standard keyboard having a plurality of button keys for entering digital data;
a keyboard micro-control unit for generating digital codes corresponding to each of the button keys and transferring the digital codes to a host which connects to the keyboard, and receiving information signals from the host including the temperature of the CPU and the rotation speed of the radiator fan;
a display device located on an input operation side of the keyboard; and
a display micro-control unit for actuating the display device to display the CPU temperature and the rotation speed of the radiator fan based on the information signals of the CPU temperature and the rotation speed of the radiator fan transferred from the keyboard micro-control unit.

2. The keyboard for displaying host operating conditions of claim 1, wherein display device is a liquid crystal screen.

3. The keyboard for displaying host operating conditions of claim 1, wherein display device is a light emitting diode display device.

4. The keyboard for displaying host operating conditions of claim 1 further having a rotation speed regulator located on the operation side of the keyboard to generate a regulation signal to be encoded by the keyboard micro-control unit and transferred to the host to alter the rotation speed of the radiator fan.

5. The keyboard for displaying host operating conditions of claim 4, wherein the rotation speed regulator is a pushbutton.

6. The keyboard for displaying host operating conditions of claim 4, wherein the rotation speed regulator is a turning knob.

7. The keyboard for displaying host operating conditions of claim 4, wherein the rotation speed regulator is a multi-stage toggle switch.

8. The keyboard for displaying host operating conditions of claim 1 further having an alarm unit to be actuated by the keyboard micro-control unit to generate an alarm signal when the temperature of the CPU and hard disk drives rises and exceeds a preset temperature and the host issues a warning signal to the keyboard micro-control unit.

9. The keyboard for displaying host operating conditions of claim 8, wherein the alarm unit is a lighting element.

10. The keyboard for displaying host operating conditions of claim 8, wherein the alarm unit is an audio element.

11. The keyboard for displaying host operating conditions of claim 8, wherein the alarm unit includes a lighting element and an audio element.
